(19) United States
(12) Patent Application Publication
(10) Pub. No.: US 2012/0223166 A1
(43) Pub. Date: Sep. 6, 2012

(54) Method of Producing Rubber Particles from Vulcanized Rubber Products

(76) Inventors: Pin-Tsung Cheng, Kaohsiung City (TW); Li-Hsiang Lin, Kaohsiung City (TW)

(21) Appl. No.: 13/449,490

(22) Filed: Apr. 18, 2012

Related U.S. Application Data
(63) Continuation-in-part of application No. 12/472,527, filed on May 27, 2009, now abandoned.

(51) Int. Cl. B02C 19/00

(52) U.S. Cl. 241/15

(57) ABSTRACT

A method of producing devulcanized and activated rubber particles from vulcanized rubber products includes providing a jet unit including a rotatable jetting head that has a plurality of self-rotating nozzles for producing an ultra-high-speed jet fluid, and impinging the vulcanized rubber products using the ultra-high-speed jet fluid. The ultra-high-speed jet fluid has a Reynold's number ranging from 100,000 to 4,000,000. The rotatable jetting head rotates at a rotating speed of not less than 2,000 rpm. Each of the self-rotating nozzles produces a jet fluid that has an initial apparent kinetic energy of not less than 10×10³ KJ.

### CROSS-REFERENCE TO RELATED APPLICATION

This application is a continuation-in-part application of U.S. patent application Ser. No. 12/472527, filed on May 27, 2009.

### BACKGROUND OF THE INVENTION

1. Field of the Invention

This invention relates to a method of producing rubber particles from vulcanized rubber products, and more particularly to a method which employs an ultra-high-speed jet fluid to disintegrate vulcanized rubber products.

2. Description of the Related Art

Natural rubber or synthetic rubber can be vulcanized by virtue of sulfur (i.e., vulcanization) or peroxides in order to produce conventional rubber products such as tires, shoe soles, rubber tubes, or rubber sheets. The rubber product that is discarded is regarded as a waste rubber product. Generally, the waste rubber products may not be transformed into recycled products that have a good chemical property or a good mechanical property by virtue of simply heating or processing the waste rubber products. Therefore, in early days, mechanical treatment is used for disintegrating the waste rubber products into sheets, granules, or powder. The recycled rubber can be used directly in a landfill, as an additive in asphalt for road pavement, or to be compounded for making low-quality goods (e.g., a rubber mat and a splashboard). During the mechanical disintegration of the waste rubber products, a reamer may give rise to heat transfer and overheating. Some portions of the vulcanized waste rubber products are consequently subject to coking due to heat induced by the reamer. As a result, the recycled rubber particles made from the waste rubber products have irregular surfaces with a great amount of coke clusters existing thereon.

In recent years, the waste rubber products have been recycled and converted into a more valuable material called reclaimed rubber that is suitable for wide applications. The waste rubber products are processed through physical and chemical processes such as disintegration, heating, depolymerization, and mechanical treatment in order to produce the reclaimed rubber that has plasticity and re-vulcanizable properties. Methods of reclaiming the waste rubber products include a direct steaming process (such as a static oil process or a dynamic oil process), steaming and boiling processes (such as a digester method process, an alkaline process, and a neutralization process), a mechanical process (such as a rapid stirring process, a process including operating a Banbury mixer, or a screw extruding process), a chemical process (such as using a solvent to soak and swell the waste rubber products which are therefore formed into liquid or semi-liquid reclaimed rubber at a high temperature, or adding an unsaturated acid to the waste rubber products to produce carboxyl-group containing reclaimed rubber at a high temperature), a physical process (such as a microwave process, a far-infraredprocess, or an ultrasonic process), etc. Among others, the oil process and the water-oil process are normally used, and require heat, a reclaiming agent (such as a softener, an activator, or a tackifier), and oxygen. Devulcanization is mainly designed for breaking the vulcanized network of the waste rubber products such that the waste rubber products are broken into a group which includes small and insoluble vulcanized fragments, and another group which includes soluble straight chain or branched chain fragments.

The reclaimed rubber can be used as an additive or for producing low-quality goods. As a filler for a shoe making material, the weight of the reclaimed rubber can be at most 10% of the weight of the shoe making material in order to confer the shoe making material a satisfactory physical property. For a non-high quality product, about 100 or more parts by weight of the reclaimed rubber powder that has a size of 40 mesh can be added. In the case of an average quality product (such as the tire), only about 10 to 20 parts by weight of the reclaimed rubber powder that has a size smaller than 100 mesh can be added. The smaller the size of the reclaimed rubber powder is, the more the reclaimed rubber powder can be added.

However, the reclaimed rubber is formed by means of complex processes and chemical reagents, and is still unable to completely replace the natural rubber, synthetic rubber, or other plastic materials. Further improvement is necessary to increase applications of the reclaimed rubber.

Since an amount of the waste rubber products is increasing, there is a need to provide a rubber material that is recycled from the waste rubber products through a simple method which does not utilize chemical reagents harmful to the environment, that is environmentally friendly like natural rubber, and that can be substituted for thermoplastic polymers or thermoplastic rubber.

### SUMMARY OF THE INVENTION

An object of the present invention is to provide a method of producing rubber particles from waste vulcanized rubber products, by which the rubber particles can be devulcanized and activated without using environmentally unfriendly chemicals.

The method includes providing a jet unit including a rotatable jetting head that has a plurality of self-rotating nozzles for producing an ultra-high-speed jet fluid, and impinging the vulcanized rubber products using the ultra-high-speed jet fluid.

The ultra-high-speed jet fluid has a Reynold's number ranging from 100,000 to 4,000,000. The rotatable jetting head rotates at a rotating speed of not less than 2,000 rpm. Each of the self-rotating nozzles produces a jet fluid that has an initial apparent kinetic energy of not less than 10×10³ KJ.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a schematic diagram to illustrate an ultra-high-speed jet fluid device that may be used in a preferred embodiment of the present invention;

FIG. 2 is a fragmentary perspective view to illustrate a jetting head of the device shown in FIG. 1;

FIG. 3 shows scanning electron microscope (SEM) photomicrographs at 100× magnification to illustrate rubber particles of examples 1 and 2;

FIG. 4 shows SEM photomicrographs at 100× magnification to illustrate the rubber particles of example 3 and comparative example 1;

FIG. 5 shows SEM photomicrographs at 300× magnification to illustrate the rubber particles of examples 1 and 2;

FIG. 6 shows SEM photomicrographs at 300× magnification to illustrate the rubber particles of example 3 and comparative example 1;

FIG. 7 shows Raman spectra for the rubber particles of example 2 and comparative example 1;

FIG. 8 shows a Raman spectrum of comparative example 2;

FIG. 9 shows Raman spectra for examples 1-3 and comparative example 3;

FIG. 10 shows small angle X-ray scattering spectra for examples 1-3, and comparative examples 2 and 3;

FIG. 11 shows wide angle X-ray diffraction spectra of examples 1-3, and comparative examples 2 and 3;

FIG. 12 shows X-ray absorption spectra of examples 1-3 and comparative examples 2-3; and

FIG. 13 is a schematic diagram to illustrate a speculative reaction mechanism that converts vulcanized rubber products into the rubber particles in the present invention.

### DETAILED DESCRIPTION OF THE PREFERRED EMBODIMENTS

The method according to the present invention may be used to devulcanize rubber particles which are disintegrated from waste vulcanized rubber products by an ultra-high-speed jet fluid device. The method may also induce a molecular rearrangement in the devulcanized rubber particles for graphitization and activation of the devulcanized rubber particles so that the devulcanized rubber particles can recover thermoplastic properties and can be provided with carbon-carbon double bonds that can be opened for vulcanization. Accordingly, the devulcanized rubber particles activated by the method of the present invention may be used to polymerize with other polymeric materials for the production of new rubber products. With the method of the present invention, waste vulcanized rubber products can be recycled without using any environmentally unfriendly chemicals.

The method according to the present invention employs an ultra-high-speed jet unit that includes a rotatable jetting head with a plurality of nozzles to produce an ultra-high-speed jet fluid for impinging waste vulcanized rubber products. The ultra-high-speed jet fluid used in the present invention has a Reynald's number ranging from 100,000 to 4,000,000. Each of the nozzles is designed so as to provide an initial apparent kinetic energy of not less than 10×10³ KJ, which is necessary to sufficiently induce graphitization and activation of the devulcanized rubble particles.

The rotating speed of the jetting head has a significant influence on a contact period (reaction period) between the ultra-high-speed jet fluid from the nozzles and the vulcanized rubber products, which will affect the properties of the rubber particles produced by the present invention. The lower the rotating speed, the longer the contact period. If the contact period is too long, high levels of thermal aging and coking can occur on the surfaces of the rubber particles, and activation of the rubber particles will be difficult. In order to increase the effect of graphitizing and activating the rubber particles, and in order to reduce thermal aging and coking, the initial apparent kinetic energy of the jet fluid from each nozzle should not be smaller than 10×10³ KJ, and the rotating speed of the jetting head should not be less than 2,000 rpm, preferably in a range of 2,000-10,000 rpm.

When the rotating speed is lower than 2,000 rpm, the levels of thermal aging and coking will increase significantly. When the rotating speed is higher than 10,000 rpm, a high power required to provide the high rotating speed of the jetting head and a high incidence of wear in the jetting head will render the method uneconomical.

The contact period (reaction period) maybe determined through a calculation with a physical theory model. In an embodiment of the present invention, the contact period is higher than about 120 μs when the rotating speed is lower than 1,000 rpm, and may be in a range of 57 - 12 μs when the rotating speed is 2,000-10,000 rpm.

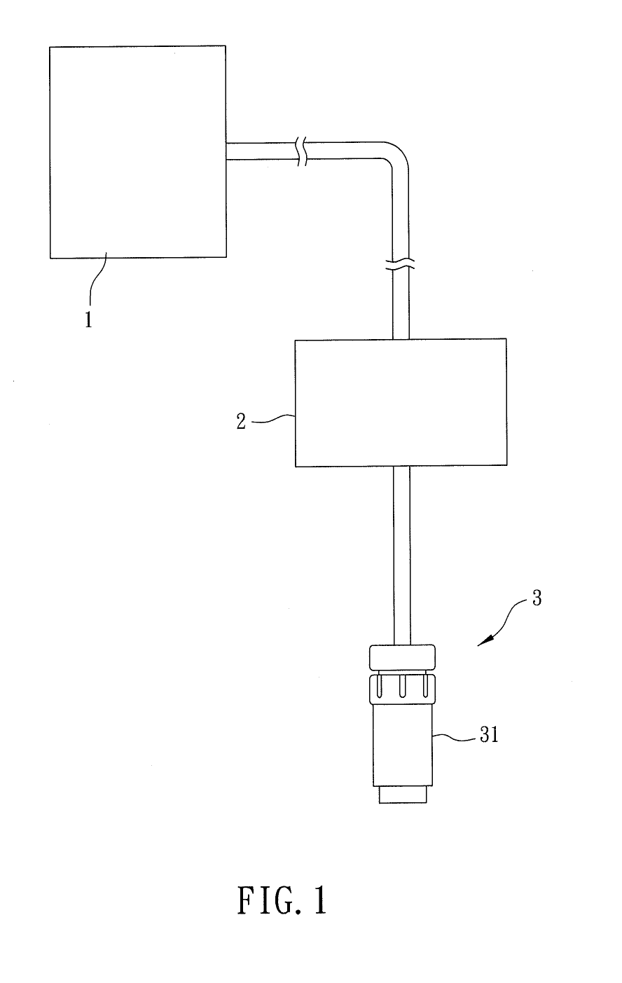

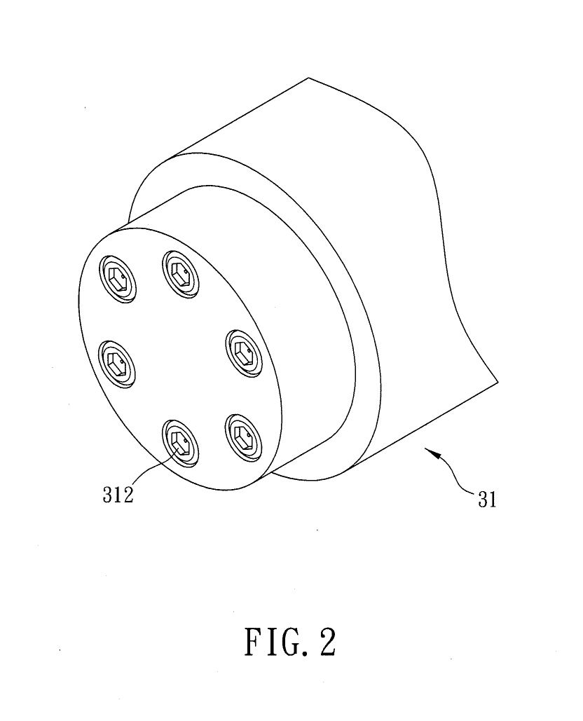

Referring to FIGS. 1 and 2, in a preferred embodiment, the ultra-high-speed jet fluid is produced by an ultra-high-speed jet fluid device that includes a fluid container 1, a pressure-increasing and temperature-controlling unit 2, and a jet unit 3. The fluid container 1 is connected to the pressure-increasing and temperature-controlling unit 2, and is adapted to contain a fluid. The jet unit 3 is connected to the pressure-increasing and temperature-controlling unit 2, and includes a jetting head 31 having a plurality of nozzles 312. Preferably, the nozzles 312 are self-rotating nozzles. The ultra-high-speed jet fluid is ejected through the nozzles 312 which are rotatable and adjustable in ejection angles. Optionally, the pressure-increasing and temperature-controlling unit 2 can be controlled to intermittently produce an output power and to rotate the nozzles 312 so that the ultra-high-speed jet fluid is converted into a rotating pulse jet two-phase fluid. Furthermore, a solid medium and/or a liquid medium other than the jet fluid may be added optionally to the jet fluid in the fluid container 1 or into a recycling container containing the vulcanized rubber products in order to enhance the impinging effect on the vulcanized rubber products.

The Reynold' s number for the ultra-high-speed jet fluid can be determined using the following equation:

$$Re = \frac{D \times {U}_{m}}{ν}$$

where Re is the Reynold's number, D is the diameter (m) of the nozzle, Uₘ is the initial fluid velocity (m/sec), and ν is kinematic viscosity (m²/sec) of the fluid, ν=μ/ρ, where μ is static viscosity of the fluid, and ρ is the density of the fluid. Preferably, the Reynold's number for the ultra-high-speed jet fluid ranges from 100,000 to 4,000,000. A Reynold's number ranging from 500,000 to 2,000,000 is more preferable from the point of view of economy and processability.

The ultra-high-speed jet fluid has the initial apparent velocity that ranges from 560 to 1150 m/sec, and initial apparent kinetic energy (based on each nozzle) not less than 10×10³ KJ. Preferably, the ultra-high-speed jet fluid has the initial apparent velocity that ranges from 620 to 750 m/sec. From the point of view of economy and processability, it is preferable that the initial apparent kinetic energy (based on each nozzle) ranges from 22×10³ to 400×10³ KJ.

When the vulcanized rubber products are impinged by the ultra-high-speed jet fluid, a temperature of an impinged area ranges from 40° C. to 95° C. Preferably, the temperature of the impinged area ranges from 45° C. to 90° C.

The vulcanized rubber products maybe made of a rubber material selected from the group consisting of polyisoprene rubber, styrene-butadiene rubber, silicone rubber, fluororubber, chloroprene rubber, ethylene-propylene diene rubber, natural rubber, and any combination thereof. The vulcanized rubber products may include waste tires, waste shoes, waste rubber tubes, waste construction bearings, waste rubber gaskets, waste shock-resistant materials, waste water-swelling rubber, waste bumpers, etc.

The rubber particles have tensile fractured surfaces. When the vulcanized rubber products are impinged, surfaces of the vulcanized rubber products are first fractured due to the impinging forces. Afterward, the ultra-high-speed jet fluid invades an interior of the vulcanized rubber products to laterally impinge C—S bonds of side chains and S—S bonds of cross-links, thereby shearing and eroding the vulcanized rubber products. Due to repeated actions of the ultra-high pressure jet fluid, the vulcanized rubber products are subjected to destructive forces, such as shearing, pulling, tearing, stretching and peeling forces and formed into a plurality of the rubber particles having the tensile fractured surfaces. Chemical reagents are not required to break the C—S bonds and the S—S bonds of the vulcanized rubber products. Consequently, the method of making the rubber particles according to the present invention is not harmful to the environment, and is suitable for mass production at low costs. Furthermore, the rubber particles have very little or no coke clusters thereon, thereby enhancing applications of the rubber particles.

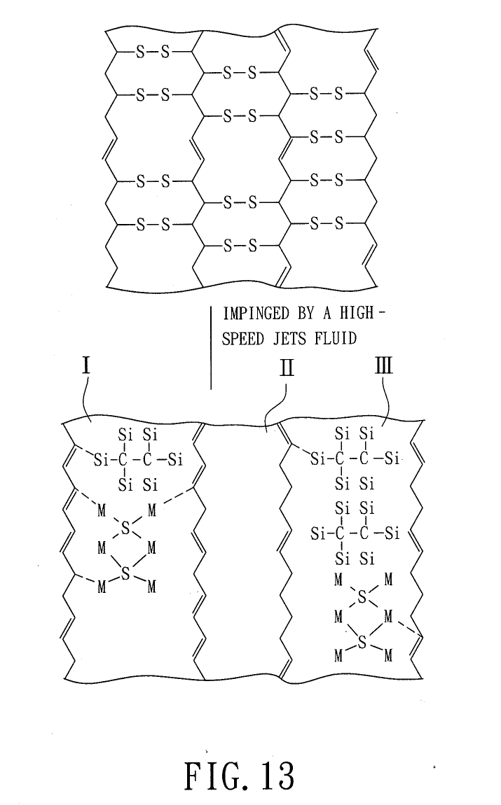

It is presumed that formation of the rubber particles from the vulcanized rubber products may be a mechanism as shown in FIG. 13. In FIG. 13, the vulcanized rubber products have S—S bonds and C—S bonds (C is present in main chains) as shown in an upper part of FIG. 13, and the rubber particles have no S—S bonds but include compounds having M—S bonds (M is transition metal) and C—Si bonds of silicon carbide as shown in a lower part of FIG. 13. The mechanism will be detailed hereinafter.

It is known that a molecular inner microstructure of a substance can be analyzed through Raman spectroscopy. In a Raman spectrum, a band at about 1332 cm⁻¹ signifies an amount of disorder in carbon materials and is called D-band, and a band at about 1580 cm⁻¹ represents graphite and is called G-band. A ratio of G-band to D-band (or a G/D value) is helpful for analyzing a composition and a structure of a substance. When a G/D value is greater than 1, a degree of carbonization is high such that electrons have a weaker tendency to move towards side-chain functional groups. This indicates that the crystal structure of graphite tends to be regular and the amount of disorder is reduced. When a G/D value is less than 1, electrons have a stronger tendency to move towards side-chain functional groups and tend to move in a radial direction, thereby resulting in a more side-band hybridized structure. In the present invention, the rubber particles have a G/D value that is measured by Raman spectroscopy and that ranges from 1 to 2. In an embodiment, the G/D value of the rubber particles ranges from 1.05 to 1.55.

According to the present invention, at least some of the rubber particles include a crystalline region. The crystalline region includes a crystalline structure of silicon carbide. Speculatively, silicon of silicon carbide comes from a filler, such as silicon oxide, added to the rubber material before vulcanization and bonded to carbon of the rubber particles to form silicon carbide which has a unit cell of a triclinic crystal system. The carbon combining with the silicon may come from the C—S bond that is cleaved due to the impinging action on the vulcanized rubber products.

The crystalline region also includes a crystalline structure of a compound containing a transition metal and sulfur. The transition metal is selected from the group consisting of zinc, titanium, manganese, iron, cobalt, nickel, and copper. Presumably, formation of this crystalline structure is due to the combining of sulfur with a transition metal to form a zinc blende structure. The sulfur resulted from cleavage of the C—S bond or the S—S bond upon impinging of the vulcanized rubber products, and the transition metal came from an accelerator added during cross-linking or an additive or a filler added before cross-linking. In an embodiment, the compound is zinc sulfide. The zinc atom of zinc sulfide may come from the accelerator, such as zinc oxide.

The rubber particles have a size that ranges from 0.019 mm to 1.5 mm. In an embodiment, the rubber particles have a size that ranges from 0.037 mm to 0.425 mm.

According to the present invention, the rubber particles may be incorporated into a polymeric matrix material. The polymeric matrix material may be polystyrene, or other rubbers. The rubber particles may be added in an amount of over 20% based on a total weight of the matrix material plus the rubber particles, and the maximum amount may be up to 83 wt %. A large amount of the rubber particles can be utilized for replacing a conventional raw rubber, a filler, or an additive (such as carbon black or silicon oxide), for production of products having enhanced impact resistance or other mechanical properties, for replacing a major material such as styrene-butadiene rubber, acrylonitrile-butadiene rubber, etc., for adding to asphalt products (e.g., emulsified asphalt and oily asphalt), and for mixing with water-proof coatings, sealants, etc. The rubber particles may also be used in making the following products: (1) a tire or a reclaimed tire; (2) a shock-absorbing device for a bridge or a machine; (3) a rubber gasket, a water-blocking device, and a non-slid device; (4) an anti-glare rubber material for a dock; (5) a packing for a railroad; (6) a shoemaking material; (7) a filler or an accelerator for rubber; (8) a rubber tube, a packaging material, and an elastic band; (9) a rubber pad, emulsified asphalt, modified asphalt, and other materials for road pavement; (10) a toy and a carpet; (11) an insulating material and a coating material; (12) modification of a plastic material such as polystyrene, acrylonitrile butadiene styrene, acrylic resin, epoxy resin, polyethylene, and polypropylene; (13) modifying a coating material so as to increase elasticity, anti-corrosion, weather resistance, and wear proof; (14) modifying a water-resistant material and a sealant so as to increase an anti-pollution capability, to reduce oil leakage and stickiness, and to lower a production cost; (15) a water-swellable rubber; (16) a shock-resistant material for an electronic device; (17) an outer case for an electronic device; (18) a photo resistor for an IC semiconductor, a printed circuit board, electronic packaging, a connector, and a dielectric film; (19) an optical disk, a liquid crystal display, a wide viewing film, a prism film, a backlight module, an organic light emitting diode, a polymer light emitting diode, an optical fiber, and a telecommunication device; (20) a biochip, a biomedical material, an artificial heart, medical equipments, and other biotechnology products. Preferably, the rubber particles are used for producing shoe making materials and high impact-resistant polystyrene.

### EXAMPLES

### Examples 1-3

### Production of Rubber Particles

The waste rubber products used for making the rubber particles include waste sheet segments of a tire that is manufactured by Japanese Dunlop Co. (Model No. SP350, 12R225, steel radial tubeless). The ultra-high-speed jet fluid device shown in FIG. 1 was developed and installed by the inventor of the present invention, and was operated to eject the ultra-high-speed jet fluid for impinging the waste sheet segments of the tire, which were placed in a container. The Reynold's number of the ultra-high-speed jet fluid was about 500,000, and the initial apparent kinetic energy for the jet fluid was about 61×10³ KJ. The rotating speed of the jetting head was 3,000 rpm and the contact period was about 40 μs. The rubber particles were sieved and classified into three groups of particles, namely, Groups A, B, and C. The particle size distributions for Groups A, B, and C are shown in Table 1.

TABLE 1

| Example | Group | Particle size (mm) |
|---|---|---|
| 1 | A | 0.425-0.15 |
| 2 | B | 0.15-0.075 |
| 3 | C | 0.075-0.038 |

### Analysis of Rubber Particles

Examples 1-3 were analyzed and compared with comparative example 1 (rubber powder recycled from a waste tire through the conventional mechanical disintegration method and obtained from Yaw Shuenn Ind. Co., Ltd., 40 mesh, used as a filler for a shoe sole material, natural rubber), comparative example 2 (high quality natural rubber obtained from Song Day Enterprises Co. Ltd.), and comparative example 3 (vulcanized rubber sheet manufactured by Japanese Dunlop Co., Model No. SP350, 12R225, steel radial tubeless).

### 1. Analysis for Physical Appearance

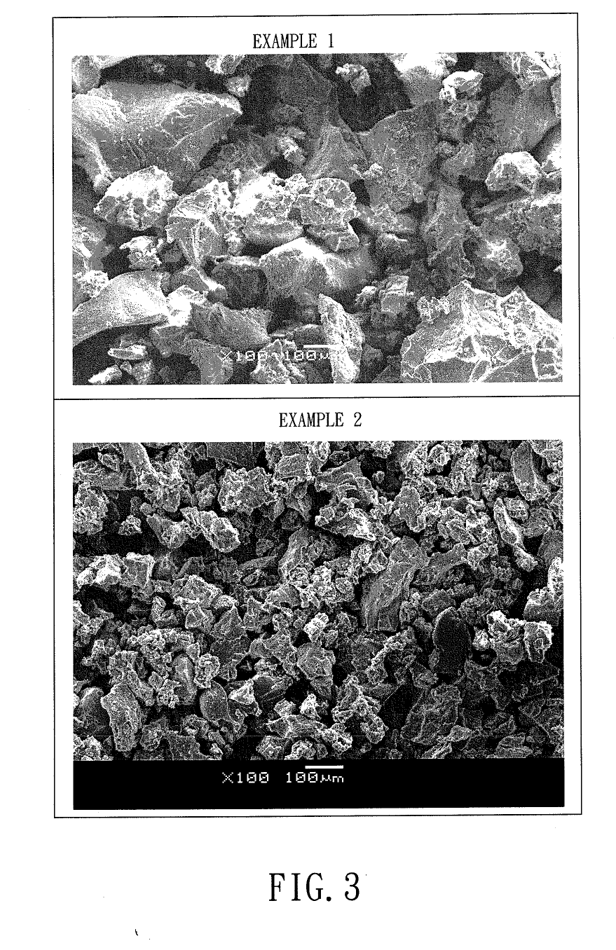

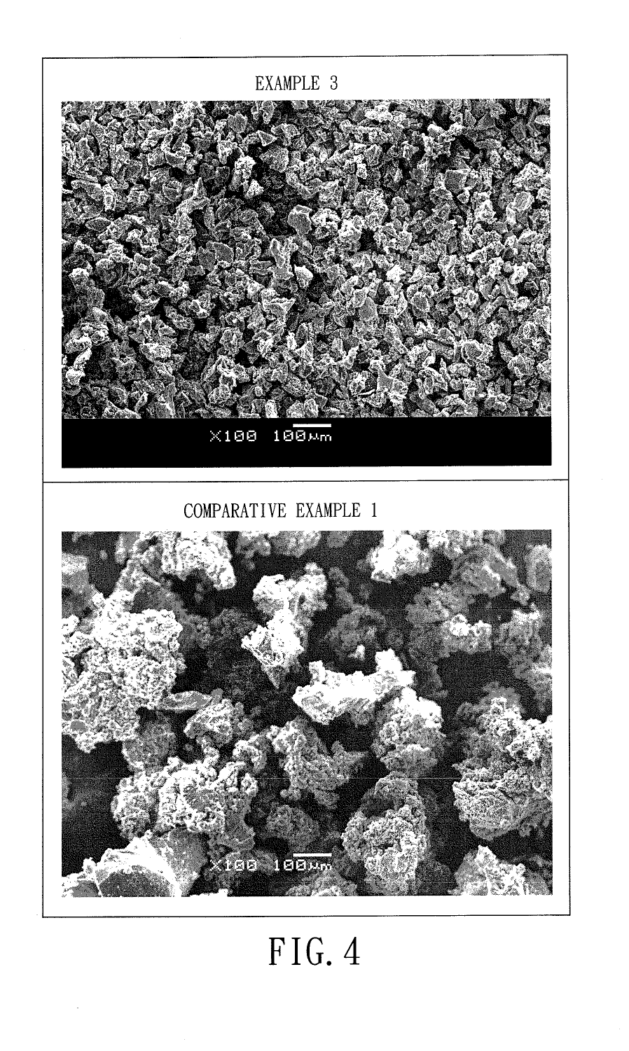

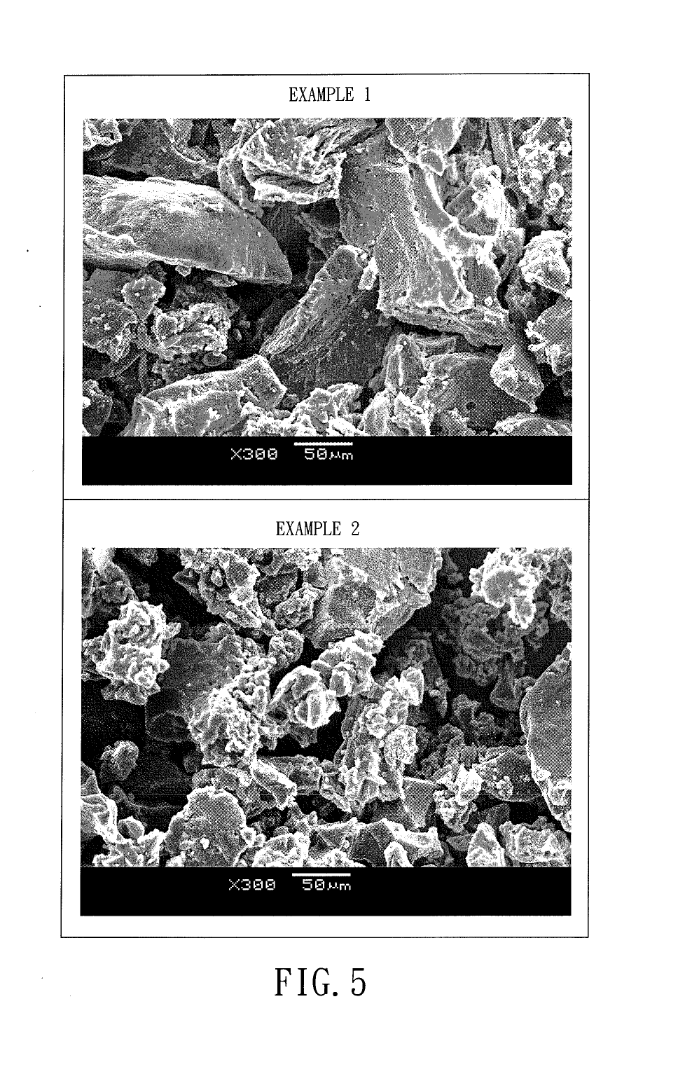

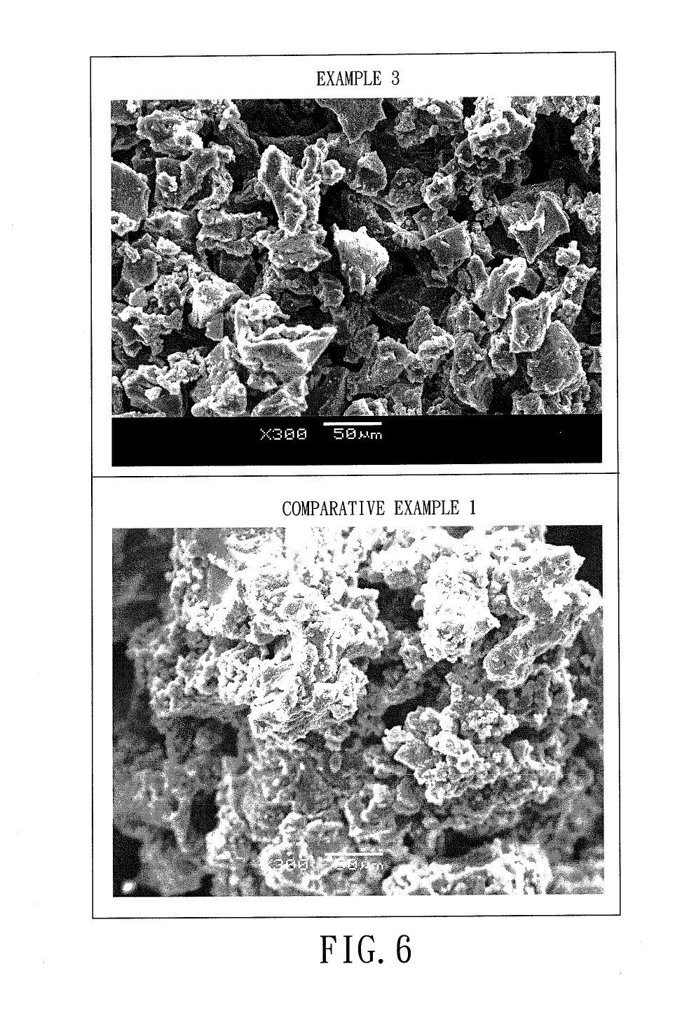

A scanning electron microscope (SEM) was used to analyze physical appearances of examples 1-3 and comparative example 1. The results are shown in FIGS. 3-6. FIGS. 3 and 4 are SEM microphotographs at 100× magnification. FIGS. 5 and 6 are SEM microphotographs at 300× magnification.

Referring to FIGS. 5 and 6, the surfaces of the particles of comparative example 1 have irregular coking clusters due to the destructive forces and the coking effect encountered in the conventional mechanical disintegration method. The coke clusters could lower a quality of the recycled rubber powder and limit the application of the same. On the contrary, the surfaces of the rubber particles of examples 1-3 do not have large amounts of coke clusters, but present tensile fractured surfaces that do not affect the application of the rubber particles. The different appearances of the examples and comparative example result from different recycling methods.

### 2. Analysis for Structure and Composition

### 2-1. Raman Spectroscopy

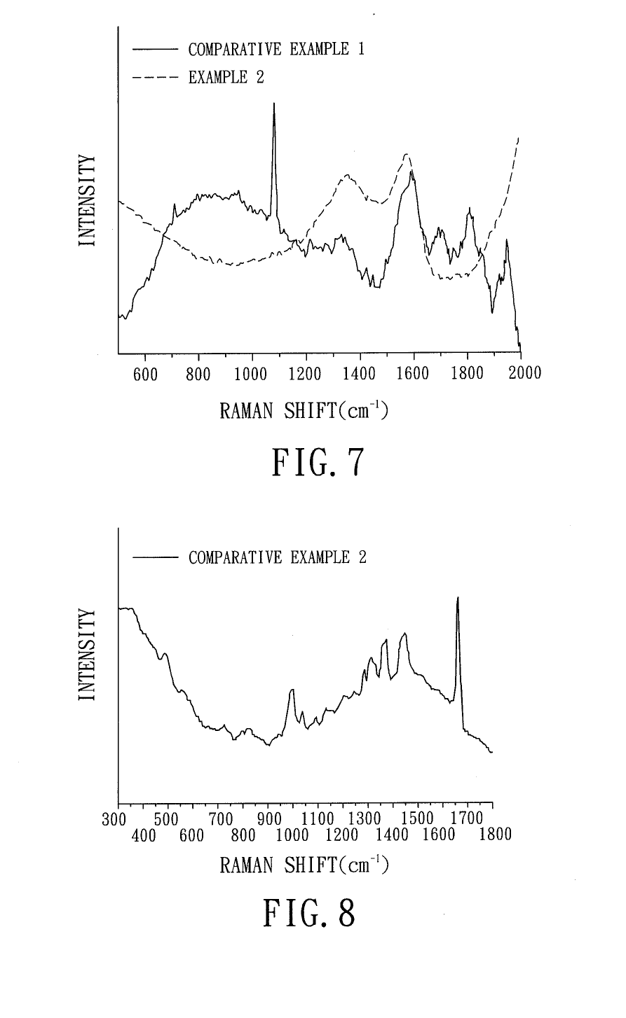

Examples 1-3 and comparative examples 1-3 were analyzed via a Raman spectrometer. FIG. 7 shows Raman spectra for comparative example 1 and example 2, and reveals that example 2 is different in molecular structure and composition from the recycled rubber powder of comparative example 1.

FIG. 8 shows a Raman spectrum for comparative example 2. Absorption bands of S—S bonds, D-band, and G-band do not appear on the Raman spectrum of the natural rubber.

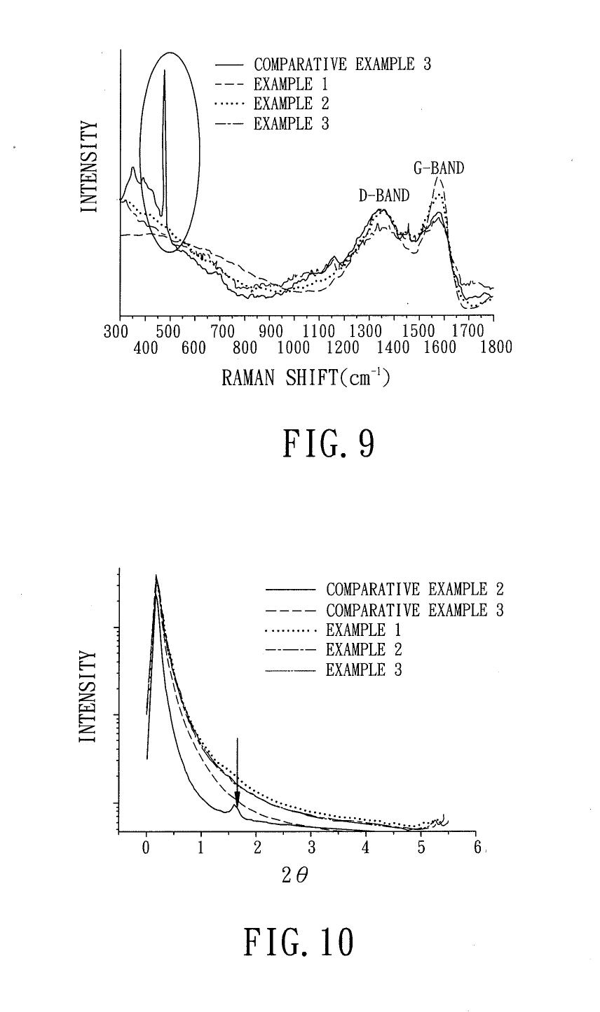

FIG. 9 shows Raman spectra for examples 1-3 and comparative example 3. An absorption band (at about 500 cm⁻¹) of S—S bonds is observed for the vulcanized rubber of comparative example 3. However, examples 1-3 have no such absorption bands of S—S bonds. Therefore, examples 1-3 are different in molecular structure and composition from the vulcanized rubber sheet of comparative example 3.

FIG. 9 further shows that D-band and G-band are present in the Raman spectrum for comparative example 3. G/D values for examples 1-3 and comparative example 3 are listed as follows: G/D of example 1 (1.22)>G/D of example 2(1.16)>G/D of example 3 (1.12)>G/D of comparative example 3 (0.77). Therefore, FIGS. 8 and 9 manifest that the molecular structures and compositions of examples 1-3 are different from those of the natural rubber of comparative example 2 and the vulcanized rubber sheet of comparative example 3.

It is noted that the G/D value of the rubber particles of examples 1-3 is proportional to the size of the same. More particularly, the bigger the size is, the greater the G/D value is. Therefore, the particle size and the level of carbonization of the rubber particles can be controlled by the method of the present invention.

2-2. Small Angle X-ray Scattering

Small angle X-ray scattering was used for analyzing examples 1-3, and comparative examples 2 and 3.

Referring to FIG. 10, the spectrum of comparative example 2 shows that the molecular structure of the natural rubber has an apparent long lattice spacing ordering and that the lattice spacing between chains is 4.65 nm (see the arrow in FIG. 10). Such a long lattice spacing ordering disappears in the spectrum of comparative example 3. This is because the lattice spacing between the main chains of the natural rubber no longer exists after vulcanization of the same. The spectra of examples 1-3 also have no long lattice spacing ordering. Hypothetically, carbonization occurs in the internal molecular structure of the rubber particles, and hence the molecules of the rubber particles undergo rearrangement. The results in FIG. 10 also manifest that the rubber particles of examples 1-3 are different from the natural rubber of comparative example 2.

### 2-3. Wide Angle X-ray Diffraction

Examples 1-3, and comparative examples 2 and 3 were analyzed by means of wide angle X-ray diffraction.

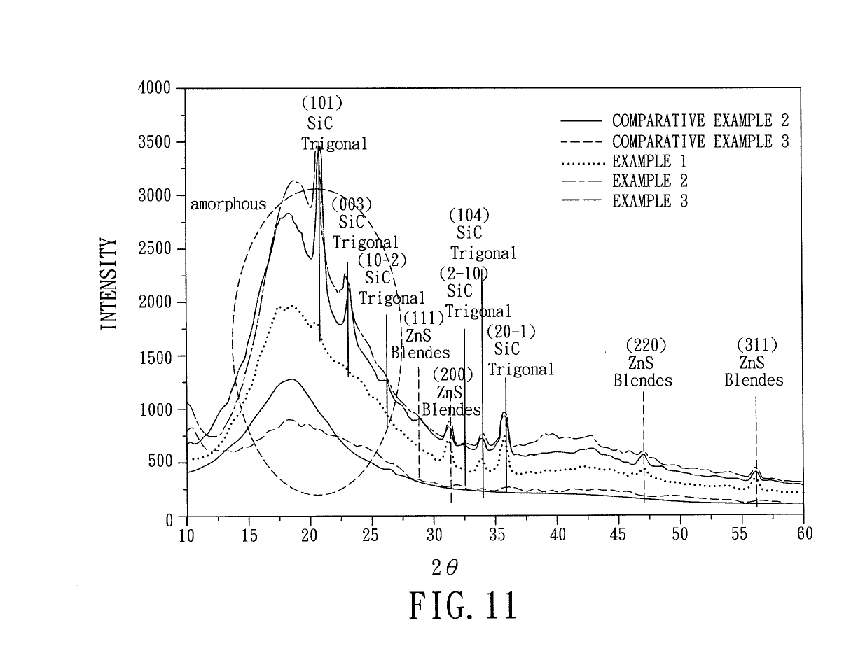

FIG. 11 shows the diffraction patterns for examples 1-3, and comparative examples 2 and 3. The circle in FIG. 11 shows that non-crystalline structure exists in all of the natural rubber of comparative example 2, the vulcanized rubber sheet of comparative example 3, and the rubber particles of examples 1-3. On the other hand, the diffraction patterns of examples 1-3 have diffraction peaks for silicon carbide having the triclinic crystal system, and for zinc sulfide having the zinc blende structure combined with other compounds MS (M is Zn, Ti, Mn, Fe, Co, Ni or Cu). The diffraction peaks of the zinc sulfide blendes appear at 111, 200, 220, and 311. No diffraction peaks of Zn—C bonds are present in the diffraction patterns of examples 1-3. This proves that the main chains of the rubber particles of examples 1-3 have no Zn—C bonds and that zinc combines with sulfur rather than carbon.

FIG. 11 further shows that the diffraction patterns of comparative examples 2 and 3 do not have diffraction peaks of silicon carbide and zinc sulfide. This indicates that examples 1-3 are different in composition and molecular structure from comparative examples 2 and 3.

FIG. 11 also shows that the diffraction peaks of silicon carbide appear on the diffraction patterns of examples 1-3 within a region where 20 ranges from 20 to 30. The intensity of the diffraction peaks of silicon carbide decreases in the order of examples 1-3 listed as follows: example 3>example 2>example 1. Hence, the smaller the particle size of the rubber particles, the larger the amount of silicon carbide resulting from carbonization induced by the ultra-high-speed jet fluid.

### 2-4. X-ray Fluorescence Spectroscopy for Elemental Analysis

An X-ray fluorescence spectrometer was used to analyze the composition of the rubber particles of example 2. The results are shown in Table 2.

25

TABLE 2

| Element | Ppm |
|---|---|
| Al | 124100 ± 6200 |
| Si | 154800 ± 11600 |
| P | 6480 ± 150 |
| S | >69520 ± 140 |
| Cl | 8396 ± 34 |
| K | 3536 ± 34 |
| Ca | 17810 ± 90 |
| Ti | 430 ± 9.9 |
| Mn | 39.1 ± 5.0 |
| Fe | 2736 ± 16 |
| Co | 181.4 ± 5.9 |
| Ni | 34.4 ± 1.6 |
| Cu | 86.4 ± 3.2 |
| Pb | 47.2 ± 1.2 |
| Zn | >26340 ± 30 |
| Ge | 2.7 ± 1.4 |
| As | 12 ± 1.0 |
| Se | 1.3 ± 0.2 |
| Br | 13.9 ± 0.4 |
| Rb | 7 ± 0.3 |
| Sr | 20.3 ± 0.4 |
| Y | 6 ± 0.4 |
| Sb | 7.2 ± 1.6 |
| Cs | 15.3 ± 5.2 |
| Ba | 73 ± 14 |
| La | 64 ± 16 |
| Tl | 4.1 ± 0.7 |

According to Table 2, example 2 not only includes Zn, Si, and S, but also has other transition metals such as Ti, Mn, Fe, Co, Ni, and Cu. Table 2 provides an evidence for the results of the wide angle X-ray diffraction analysis that the rubber particles have silicon carbide and the compounds (MS).

### 2-5. X-ray Absorption Spectroscopy

An X-ray absorption spectrometer was utilized to analyze examples 1-3, and comparative examples 2 and 3.

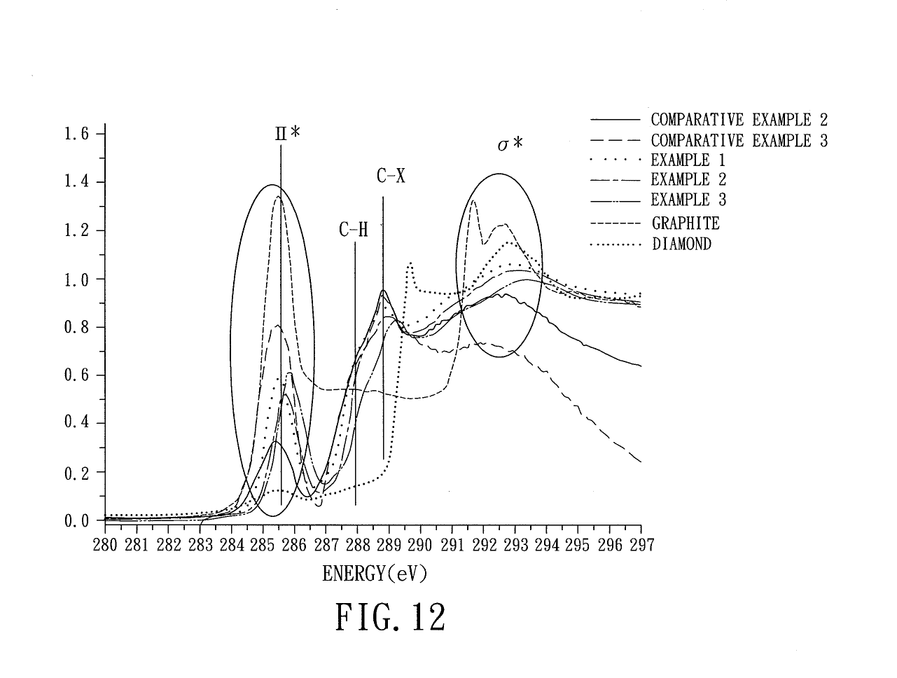

FIG. 12 shows spectra for examples 1-3, comparative examples 2 and 3, graphite, and diamond. Absorption bands of sp² hybrid orbitals (symbolized by Π*), sp³ hybrid orbitals (symbolized by σ*), C—H bonds, and C—X bonds (X denotes nitrogen, silicon, sulfur, etc.) appear in the spectra. The spectrum of the natural rubber (comparative example 2) has a weak absorption peak of sp² compared to that of the vulcanized rubber sheet (comparative example 3). Speculatively, the C—S bonds of the vulcanized rubber sheet give rise to a stronger absorption peak of sp².

In contrast with the vulcanized rubber sheet, the rubber particles of examples 2 and 3 have absorption bands of sp² shifting to high energy level since fewer electrons are adjacent to carbon, and the electron affinity of carbon is smaller than that of silicon. Therefore, when the C—S bond is formed, because of the higher electron affinity of silicon, electrons of carbon tend to move towards silicon so that energy increases at the center of sp2, thereby shifting the absorption peak to a high energy level.

According to the spectra of examples 1-3, the absorption peak of sp² for example 3 has the highest energy, whereas the absorption peak of sp² for example 1 has the lowest energy. This indicates that the smaller the particle size, the larger the amount of C—S bonds and the stronger the energy of the sp² absorption peak.

### 2-6. Quantitative Analysis for Polyisoprene

Polyisoprene content in each of examples 1-3 and comparative examples 2-3 was determined by means of ISO 5954-1989. The results are shown in Table 3.

TABLE 3

| | | | | Compar- | Compar- |
|---|---|---|---|---|---|
| | | | | ative | ative |
| | Example 1 | Example 2 | Example 3 | example 2 | example 3 |
| Polyisoprene | 31.08 | 33.03 | 31.18 | 59.16 | 6.50 |
| content | | | | | |
| (wt %) | | | | | |

According to Table 3, comparative example 2 includes the highest polyisoprene content (i.e., the largest numbers of double bonds). The polyisoprene content in comparative example 3 is reduced compared to that of comparative example 2, since double bonds of polyisoprene molecules are destroyed due to formation of cross-links (S—S bonds). Each of examples 1-3 has a polyisoprene content that increases considerably compared to comparative example 3. According to the results of the wide angle X-ray diffraction analysis, each of examples 1-3 also has the bond of the compound (MS). In FIG. 13, the transitional metals of the compounds (MS) are denoted by M that represents Zn, Ti, Mn, Fe, Co, Ni, or Cu. Each dotted line represents a weak force (e.g., Van der Waal's attraction) between a neutral atom or a molecule and a main chain. For example, an additive or a filler is dispersed around a molecular structure through such weak forces. After the S—S bonds are destroyed by the ultra-high-speed jet fluid, some S—S bonds are converted into M—S bonds (zinc blende, see the bottom of FIG. 13) or desulfurization occurs so that most of polyisoprene molecules having double bonds are restored and the numbers thereof are increased. The M—S compounds and silicon carbide are dispersed between the main chains of the rubber particles through the weak attraction forces. The weak attraction forces are present between carbon atoms of the main chains and the MS compounds, between the carbon atoms of the main chains and silicon carbide, and even between the MS compounds and silicon carbide. There are no covalent bonds between the MS compounds and the main chains, and between silicon carbide and the main chains (see zone I and zone III in FIG. 13). Referring to zone II in FIG. 13, none of the additive and the filler exists between the main chains in zone II (i.e., none of the crystalline structures are formed in zone II). The molecular structure shown in zone II is similar to that of the unvulcanized polyisoprene molecules (raw rubber).

The reason why not all of the double bonds of polyisoprene can be recovered in the rubber particles of the present invention is presumably that the main chains undergo rearrangement due to breakage of side-chain functional groups. This result is evident from the results of FIG. 13 in combination with that of FIG. 12 which shows that the energy levels of the absorption band of SP² (Π*) for examples 1-3 are relatively high compared to comparative examples 2-3.

### Application of Rubber Particles

### Production of High-Impact Resistant Polystyrene Product

Synthetic rubber (acquired from Eternal Prowess Taiwan Co., Ltd., trade name: Chimei Q resin PB 5925, a blend of butadiene rubber and polystyrene) was mixed with the rubber particles of example 1, and a peroxide cross-linking agent according to the percentages of the components listed in Table 4. Mixing was carried out in a twin screw masticator at a controlled temperature of 150° C. for 3 minutes. The resulting mixture was put into a closed-type double roller banbury mixer, and was processed at 150° C. for 600 seconds by means of compression molding. Finally, products A, B, and C were formed.

TABLE 4

| | Product | | |
|---|---|---|---|
| Component | A | B | C |
| Synthetic rubber | 25% | 50% | 75% |
| Rubber Particles of | 75% | 50% | 25% |
| example 1 | | | |
| Peroxide | 0.5% | 0.5% | 0.5% |
| cross-linking agent | | | |

Products A, B, and C were tested for hardness and IZOD impact resistance. The hardness was measured according to ASTM D2240-05. The IZOD impact resistance was tested via ASTM D256-06a Method A. The results are shown in Table 5.

TABLE 5

| | Synthetic | Product | | |
|---|---|---|---|---|
| | rubber | A | B | C |
| Hardness | 40°~60° | 91° | 98° | 99° |
| (type D) | | | | |
| IZOD impact | 2.5 | 31 | 48 | 25 |
| resistance | | | | |
| (Kg-cm/cm) | | | | |

According to Table 5, the hardness of the products A, B, and C is greater than that of the synthetic rubber used to make products A, B, and C. This reveals that the rubber particles of example 1 can increase hardness of the synthetic rubber.

The synthetic rubber used for making products A, B, and C has an impact resistance (IZOD) of 2.5 Kg-cm/cm. The IZOD impact resistance of products A, B, and C increases to 25 Kg-cm/cm and even up to 48 Kg-cm/cm. Therefore, the rubber particles of example 1 can increase the impact resistance.

### Production of Rubber Sheet

17 g of natural rubber, 83 g of the rubber particles of example 1, 2 g of stearic acid, and 2 g of sulfur and an accelerator were mixed together in an open-type twin roller kneader at a temperature of about 25° C.-28° C., and were thereafter processed at 140° C. for 200 minutes through compression molding such that rubber sheet I was formed.

Rubber sheet II was made by following the aforesaid procedure for making rubber sheet I but replacing the rubber particle of example 1 with recycled rubber powder produced by the conventional mechanical disintegration method.

Rubber sheets I and II were tested for the following properties:
1. Tensile strength N/mm² (tested according to ASTM D412-06a);
2. Elongation % (tested according to ASTM D412-06a);
3. Hardness type A/1 SEC (tested according to ASTM D2240-05); and
4. Tear strength Kgf/cm (tested according to ASTM D624-00e1).

The results are shown in Table 6.

TABLE 6

| Properties | Rubber sheet I | Rubber Sheet II |
|---|---|---|
| Tensile strength | 123 | 69.0 |
| Elongation | 337 | 252 |
| Hardness | 58 | 52 |
| Tear strength | 32.3 | 20.9 |

The results of Table 6 show that the properties of rubber sheet I are better than those of rubber sheet II. Therefore, the rubber particles of example 1 could efficiently enhance mechanical properties such as tensile strength, elongation, hardness, and tear strength compared to the conventionally recycled rubber powder.

The results of Table 6 further show that good mechanical properties can be achieved even when example 1 is used in a large amount, i.e., up to 83% of a total weight of the composition to make rubber sheet I. This would indicate that the rubber particles of the present invention can be substituted for natural rubber, synthetic isoprene rubber, butadiene rubber, etc.

### Example 4

### Production of Rubber Particles

Rubber particles in Example 4 were produced through a procedure substantially similar to that of Examples 1-3. The Reynold's number of the ultra-high-speed jet fluid was about 800,000. The rotating speed of the jetting head was about 3,950 rpm. The contact period was about 29 μs. The jet fluid from each nozzle had an initial apparent kinetic energy of about 98×10³ KJ. The resulting rubber particles were sieved and classified. The rubber particles with 40 mesh (0.425 mm) were analyzed. It was observed that the number of carbon-carbon double bonds in the analyzed rubber particles was 31-33 and the G/D value was up to 1.41. The results indicate that the rubber particles undergo molecular rearrangement and thus have a high level of graphitization and a high level of activation for presenting thermoplastic properties.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method of producing devulcanized and activated rubber particles from vulcanized rubber products, comprising:
providing a jet unit including a rotatable jetting head that has a plurality of self-rotating nozzles for producing an ultra-high-speed jet fluid; and
impinging the vulcanized rubber products using the ultra-high-speed jet fluid;
wherein the ultra-high-speed jet fluid has a Reynold's number ranging from 100,000 to 4,000,000, the rotatable jetting head rotates at a rotating speed of not less than 2,000 rpm, and each of the self-rotating nozzles produces a jet fluid that has an initial apparent kinetic energy of not less than 10×10³ KJ.

2. The method as claimed in claim 1, wherein the rotating speed of the rotatable jetting head ranges from 2,000-10,000 rpm.

3. The method as claimed in claim 1, wherein the ultra-high-speed jet fluid further has an initial apparent velocity that ranges from 560 to 1150 m/sec.

4. The method as claimed in claim 1, wherein a temperature of an impinged area in the vulcanized products ranges from 40° C. to 95° C.

5. The method as claimed in claim 1, wherein the jet unit is controlled to intermittently produce an output power and to rotate the nozzles.

6. The method as claimed in claim 1, wherein each of the self-rotating nozzles produces a jet fluid that has an initial apparent kinetic energy ranging from 22×10³ to 400×10³ KJ.
